(19) United States
(12) Patent Application Publication
(10) Pub. No.: US 2024/0379107 A1
(43) Pub. Date: Nov. 14, 2024

(54) REAL-TIME AI SCREENING AND AUTO-MODERATION OF AUDIO COMMENTS IN A LIVESTREAM

(71) Applicant: Sony Interactive Entertainment Inc., Tokyo (JP)

(72) Inventor: Warren Benedetto, San Mateo, CA (US)

(21) Appl. No.: 18/314,766

(22) Filed: May 9, 2023

(51) Int. Cl. G10L 15/26; G06F 40/30; G06F 40/40; H04N 21/2187

(52) U.S. Cl. CPC G10L 15/26; G06F 40/30; G06F 40/40; H04N 21/2187

(57) ABSTRACT

An audio comment feature is added to livestream chat. A viewer of the livestream can record a voice clip and post that audio comment to the chat. A screening system ingests the audio clip, converting it to text using a speech-to-text algorithm. The text version of the audio clip is processed by an AI moderation algorithm to filter out objectionable content. Clips that pass through the filter are displayed to the livestreamer as a text comment with an option to play the audio live on the air. The livestreamer can watch this feed of text comments during the stream. Upon identifying a comment worth broadcasting on the stream, the streamer can click a Play button on the text version of the comment to play the audio version of the comment live on the stream.

### FIELD

The present application relates generally to real-time AI screening and auto-moderation of audio comments in a livestream.

### BACKGROUND

Livestreamers on services like Twitch, Instagram Live, YouTube Live, and TikTok Live broadcast to hundreds, thousands, even millions of fans in real time. The streams usually involve a single person in front of an Internet-connected camera or smartphone, talking to the audience directly via the camera.

One way these streamers keep their streams interesting is to have a live, real-time chat running, where viewers can type in text or emoji reactions to what the streamer is doing or saying.

### SUMMARY

As understood herein, the streamer may read these text comments on stream as a way of engaging with the audience. However, popular streams can have dozens or hundreds of chat comments per minute, making the stream of comments basically unreadable because they fly by so fast.

In similar media such as talk radio, listeners are able to call into the show to ask the host a question or to comment on what the host has said. This adds a different dimension to the show because callers can hear themselves (or people like them) on the air, instead of just hearing the host reading text comments in his/her own voice.

Such a “call-in” mechanic isn't practical to do with a livestream, however, because there is generally no way for the streamer to screen the call. Whereas a talk radio show has staff to answer calls and make sure the call is legitimate and has an interesting question, the streamer is typically working alone and must be providing an entertaining livestream during their entire broadcast-they can't be simultaneously screening audio calls while they stream.

Even with a separate person screening calls, a talk radio host will sometimes be trolled by a disingenuous caller who makes it past the screener. The caller will curse live on the air, berate the host, or otherwise behave in a disruptive manner. The risk of this kind of bad behavior is especially high for livestreamers, due to the types of audiences they attract. If they were to allow any type of user's call to go out on their stream unscreened, they would be at high risk of people saying offensive things. Therefore, livestreamers generally don't allow their viewers' voices to go out live on their streams.

It is in this context that present principles arise.

Accordingly, a system includes at least one computer medium that is not a transitory signal and that in turn includes instructions executable by at least one processor assembly to receive from at least a first viewer of a computer network livestream at least one audio comment. The instructions are executable to convert the audio comment to text and to use at least one machine learning (ML) model to process the text to identify whether the text contains first content. Responsive to the text not containing first content, the instructions are executable to present the text on at least one display of a person generating the livestream, and responsive to the person selecting the text, send the audio comment with the livestream.

The first content may include one or more of profanity, hate speech, personally-identifiable information, or a topic different from a topic being discussed in the livestream (off-topic).

In some examples the instructions can be executable to allow the person generating the livestream to define the first content to be identified by the ML model.

In example implementations the instructions may be executable to present on the display along with the text at least one selector selectable to cause the audio comment to be inserted into the livestream.

If desired, the instructions can be executable to indicate that first text represents first content for a first segment of the livestream and to indicate that first text does not represent first content for a second segment of the livestream.

In another aspect, a method includes analyzing audio associated with a livestream, and automatically blocking the audio from being included in the livestream responsive to the audio containing a first characteristic.

The first characteristic can include one or more of profanity, hate speech, personally-identifiable information, off-topic content, or non-verbal audio feature. The audio can be spoken by a livestreamer transmitting the livestream or by a viewer of the livestream.

In another aspect, an apparatus includes at least one processor assembly configured to identify at least one word spoken by a person associated with a livestream, and identify whether the word is of a class not desired to be presented in the livestream. The processor is configured to, responsive to the word being of a class not desired to be presented in the livestream, block audio of the word from being sent in the livestream.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 illustrates a game advice system employing a generative pre-trained transformer (GPTT) consistent with present principles;

FIG. 3 illustrates an example computer network livestreaming system;

FIG. 4 illustrates an example screen shot of an example livestream listener display;

FIG. 5 illustrates an example screen shot of an example livestreamer display;

FIG. 6 illustrates a block diagram of an example filter system for audio comments;

FIG. 7 illustrates example viewer device logic in example flow chart format;

FIG. 8 illustrates example comment processing logic in example flow chart format which may be performed by any one or more of the devices described herein;

FIG. 9 illustrates example filtering logic in example flow chart format which may be performed by any one or more of the devices described herein;

FIG. 10 illustrates example livestreamer device logic in example flow chart format;

FIG. 11 illustrates example alternate video comment logic in example flow chart format which may be performed by any one or more of the devices described herein;

FIG. 12 illustrates an example screen shot of an example livestreamer display consistent with FIG. 11;

FIG. 13 illustrates an example screen shot of an example livestream viewer display consistent with FIG. 11;

FIG. 14 illustrates example ancillary logic in example flow chart format;

FIG. 15 illustrates example livestream-side filter logic in example flow chart format; and

FIG. 16 illustrates an example screen shot of an example livestreamer display consistent with FIG. 15.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

A processor may be a single- or multi-chip processor that can execute logic by means of various lines such as address lines, data lines, and control lines and registers and shift registers. A processor assembly may include one or more processors acting independently or in concert with each other to execute an algorithm.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

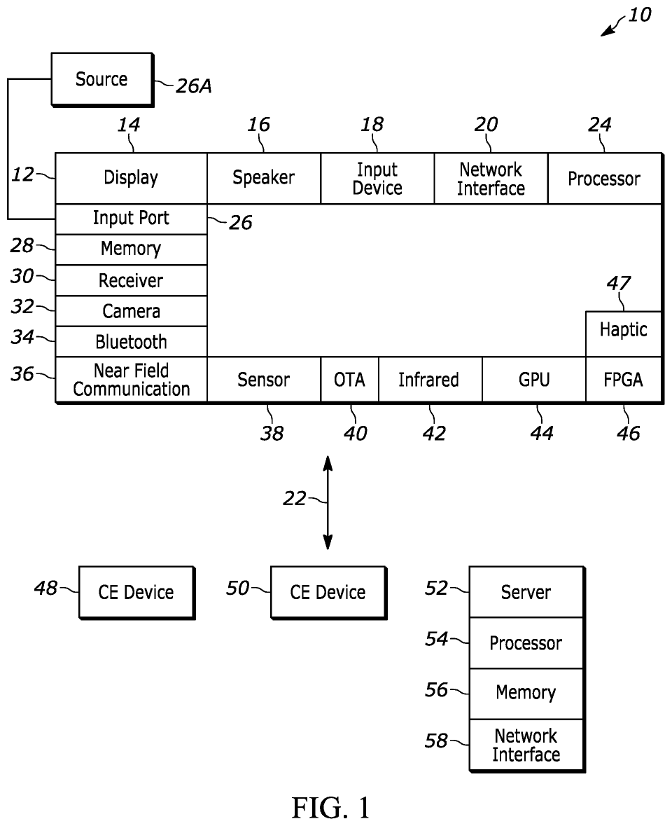

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a HMD, a wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a USB port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a, when implemented as a game console, may include some or all of the components described below in relation to the CE device 48.

The AVD 12 may further include one or more computer memories 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimension or by an event-based sensors.

Continuing the description of the AVD 12, in some embodiments the AVD 12 may include one or more cameras 32 that may be a thermal imaging camera, a digital camera such as a webcam, an event-based sensor, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 (e.g., a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command), providing input to the processor 24. The AVD 12 may include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics generators 47 may be provided for generating tactile signals that can be sensed by a person holding or in contact with the device.

Still referring to FIG. 1, in addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other devices of FIG. 1 over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown in FIG. 1 or nearby.

The components shown in the following figures may include some or all components shown in FIG. 1. The user interfaces (UI) described herein may be consolidated, expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. However, a preferred network contemplated herein is a generative pre-trained transformer (GPTT) that is trained using unsupervised training techniques described herein.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

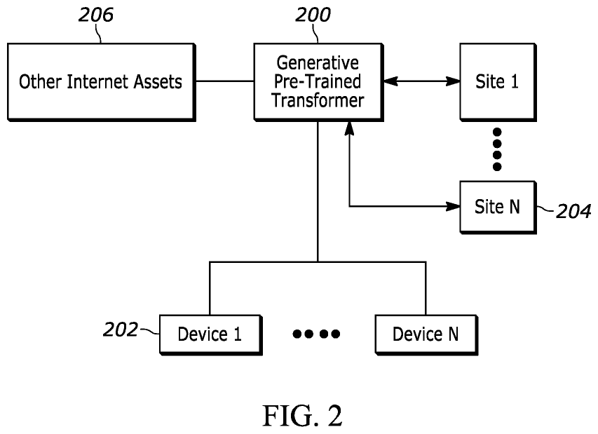

Turning to FIG. 2, in general, a generative pre-trained transformer (GPTT) 200 such as may be referred to as a “chatbot” receives queries from user computer devices 202 and based on being trained on a wide corpus of documents including gamer comments on various sites 204 such as social media sites as well as other Internet assets 206, returns a response in natural human language either spoken or written.

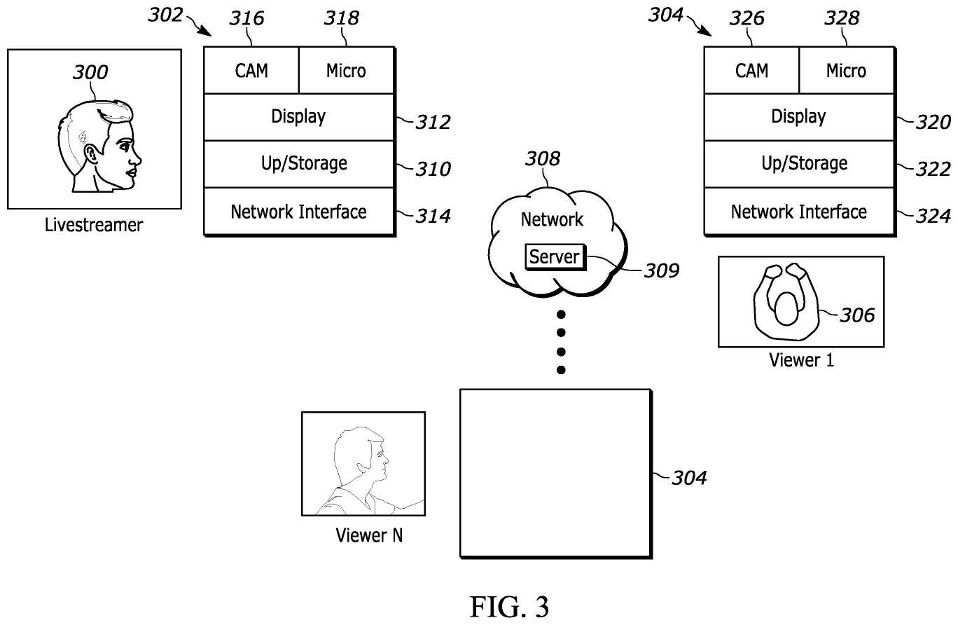

FIG. 3 illustrates a person 300 livestreaming a video, e.g., of himself using a livestream computer 302 to viewer computers 304 being watched by viewers 306. The livestream may be sent via a wide area computer network (WAN) 308 associated with one or more server or cloud computers 309. Connectivity may be wired or wireless or a combination thereof.

In the example shown, the livestream computer 302 includes at least one processor 310 with computer storage controlling at least one video display 312, typically including or being associated with at least one audio speaker as well as a video display, and at least one network interface 314 for communicating with the WAN 308. The processor 310 may receive images of, for example, the livestreamer 300 from one or more cameras 316 as well as audio spoken by the livestreamer from one or more microphones 318.

If desired, a viewer computer 304 may include components similar to those shown for the livestream computer 302. For example, a viewer computer 304 may include at least one processor 320 with computer storage controlling at least one video display 322, typically including or being associated with at least one audio speaker as well as a video display, and at least one network interface 324 for communicating with the WAN 308. The processor 320 may receive images of, for example, the viewer 306 from one or more cameras 326 as well as audio spoken by the viewer from one or more microphones 328.

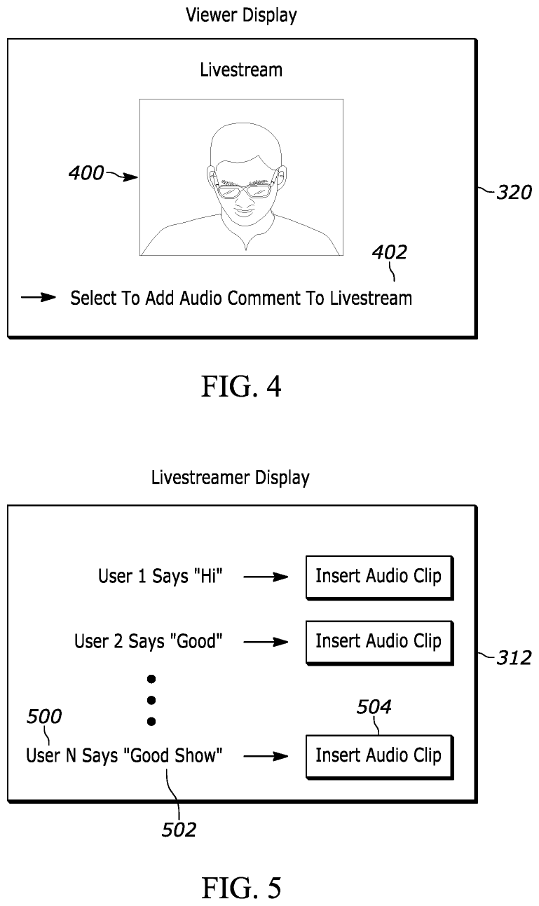

FIG. 4 illustrates that the viewer display 320 shown in FIG. 3 may present a livestream video 400, including audio. The viewer display 320 may also present an audio and/or visual prompt 402 for the viewer to speak an audio message the viewer would like to have added to the livestream in the manner of a chat comment. The viewer may select the prompt 402 to acuate the microphone of the viewer computer to record a spoken message uttered by the viewer.

FIG. 5 illustrates that the livestream computer display 312 shown in FIG. 3 may present a list 500 of viewer comments 502 in text format received during the livestream. The identity of each commenting viewer may be indicated. For each comment, a selector 504 may be presented and selectable by the livestreamer to add an audio clip represented by the respective text comment to the livestream, typically immediately.

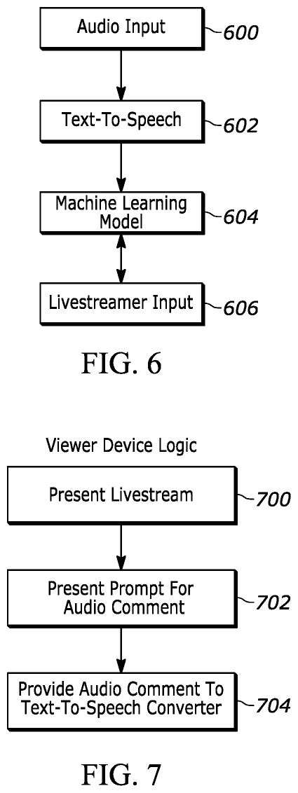

FIG. 6 et seq. illustrate principles underlying the techniques shown in FIGS. 3-5. The components of FIG. 6 may be embodied in any one or more of the computers herein working cooperatively synchronously or asynchronously.

In FIG. 6, audio comments from a viewer are received at an audio input 600 and converted to text by a text-to-speech (TTS) converter 602 that may be implemented by one or more machine learning (ML) models. The output of the TTS converter 602 may in turn be sent to ML model 604 such as a GPTT or other neural network to identify whether the text from the TTS converter 602 contains content that may be thought of as objectionable. Examples of such content include profanity, hate speech, and personally-identifiable information. Such content may also include off-topic content the character of which may change over time, e.g., during a portion of a livestream dealing with sports, a comment related to politics may be identified as objectionable while during a portion of the livestream dealing with politics, a comment about sports may be identified as objectionable.

Now refer to FIG. 7. A viewer computer presents the livestream at block 700. At block 702 the above-mentioned prompt is presented for a viewer to make an audio comment or message for the livestream by speaking into the microphone. Typically the clip is of limited duration, e.g., fifteen to twenty seconds. The audio comment is provided to the TTS converter 602 shown in FIG. 6.

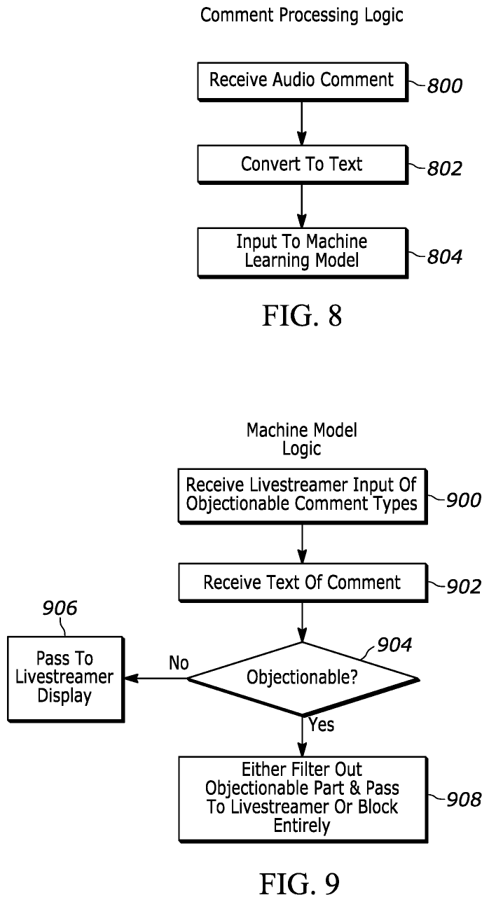

FIG. 8 illustrates example comment processing logic in example flow chart format which may be performed by any one or more of the devices/computers described herein/Commencing at block 800, the audio comment is received and at block 802 converted to text. The text is input to the ML model 604 shown in FIG. 6 at block 804.

FIG. 9 illustrates example filtering logic in example flow chart format which may be performed by any one or more of the devices/computers described herein. Commencing at block 900, livestreamer indications can be received of what does and does not constitute objectionable content. Then, the text from block 804 of FIG. 8 is received at block 902 and analyzed at state 904 to determine if the text contains objectionable content, either as defined by the livestreamer at block 900 and/or as defined by default. Responsive to the text not containing objectionable content, the text is sent to the livestream computer display at block 906 to present the text visually and/or audibly. As will be discussed shortly, responsive to the livestreamer selecting the text, the original audio comment from which the text was generated is sent in the livestream to viewers.

However, responsive to the text containing objectionable content, the logic moves from state 904 to block 908. At block 908, either the objectionable portion of the text is filtered out and the remainder is passed to the livestream computer, or the text is entirely blocked from being presented on the livestream computer. In the former instance, if the livestreamer subsequently selects the filtered text, a filtered version of the original audio clip is presented consistent with the filtered-out text.

It is to be understood that the ML model may be trained on a training set of terms and ground truth labels as to categories of the terms, with certain categories being labeled as “objectionable”. Moreover, the model may be trained to recognize topics of phrases using a training set of phrases and ground truth labels as to what topics the phrases are associated with for subsequent screening of off-topic viewer messages.

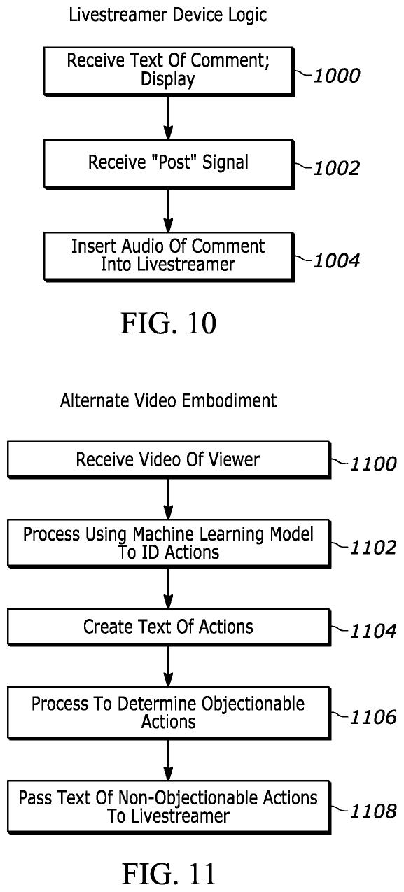

FIG. 10 illustrates example livestreamer device logic in example flow chart format in which a text comment that passes the test of FIG. 9 is provided to the livestream computer at block 1000. Moving to block 1002, a post signal is received, e.g., responsive to the livestreamer selecting a selector 504 from FIG. 5 associated with the text. The audio clip from whence the text was generated is inserted into the livestream at block 1004 and sent to the viewers of the livestream.

The livestreamer can watch the feed of text comments during streaming. The livestreamer can feel secure in knowing that the comments in the feed have been filtered to remove anything unwanted in the livestream. Also, the sheer volume of comments to view will be far lower than it would be absent present principles, because only the most substantive comments will make it through the moderation algorithm. The livestreamer can read the text of the comment (silently) to identify comments that may be interesting, funny, controversial, entertaining, etc. for the audience.

Upon identifying a comment worth broadcasting on the stream, the livestreamer can click the post selector 504 on the text version of the comment which would play the audio version of the comment live on the stream. The livestreamer can then react to that comment with his own live commentary.

The end result for the audience would be an effect much like a live caller calling into a talk radio show, but without the risk that the caller might say something offensive or unexpected once live on the air. It allows the audience to hear the voices of themselves or people like them on the stream, which can make for a more engaging and interactive viewing experience.

FIG. 11 illustrates example alternate video comment logic in example flow chart format which may be performed by any one or more of the devices described herein. A video of a viewer may be received at block 1100. Moving to block 1102, the video can be processed using an ML model trained to recognize and categorize physical actions of the viewer, such as making a particular gesture or expression or executing a particular motion. To this end the ML model can be trained on a training set of videos of people executing actions with ground truth labels indicating what the actions are.

Proceeding to block 1104, the ML model outputs text representing the viewer's action depicted in the video at block 1100. The text is processed by an ML model at block 1106 to identify whether it describes any objectionable actions. For example, certain gestures may be defined as objectionable, or certain facial expressions. The model may be trained on a training set of text describing actions along with ground truth labels indicating whether the text describes an objectionable action. Text describing non-objectionable actions may be presented on the display of the livestreamer at block 1108.

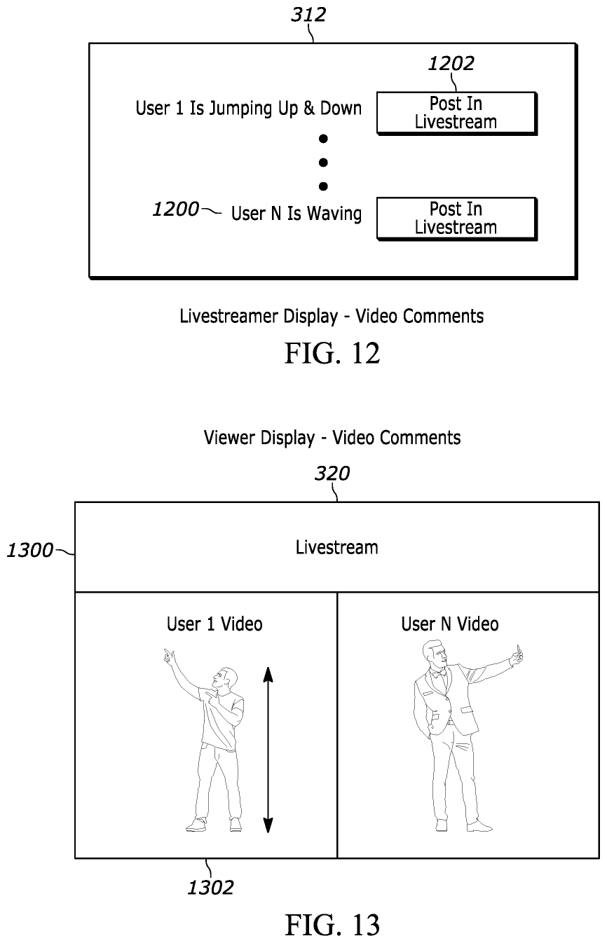

FIG. 12 illustrates. A column of text “comments” 1200 describing actions of viewers and indicating the viewer ID if desired is presented on the livestreamer's display 312. Post selectors 1202 are next to each comment to allow the liverstreamer to select to add the video associated with the text to the livestream, as shown in FIG. 13, which shows an example screen shot of an example livestream viewer display consistent with FIG. 11 in which the livestream 1300 of the livestreamer is presented on a viewer display 320 along with videos 1302 in smaller windows of viewers executing the actions described in the text comments 1200 of the livestreamer display 312.

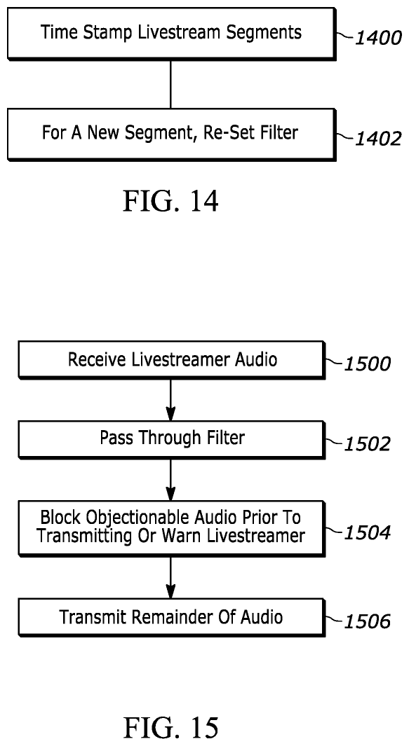

FIG. 14 illustrates example ancillary logic in example flow chart format illustrating topical and semantic analysis. As understood herein. comment moderation can go beyond just filtering out objectionable content. It can also select or highlight content based on relevance to the topic of the livestream. What is relevant or not may change during the livestream, as the livestreamer changes topics. Because livestreams are often many hours long, the streamer may cover a range of topics over time. The machine learning algorithm detects these changes and associates them with timestamps. For example, if the livestream is about politics, the timeline might be labeled with contextual information such as “00:00-05:00 election interference, voting rights, misinformation” and “05:01-07:45 gun control, mass shootings, Uvalde, Sandy Hook” which indicate the topics discussed during those blocks of time.

The text of a livestream may be analyzed by a machine learning algorithm to build a contextual and semantic understanding of the content of livestream. This understanding can be more general or specific depending on the length of time being analyzed. For example, an analysis of an entire livestream might conclude that one stream is about “sports” and another is about “politics.” Looking at smaller increments of time, say five-to-ten-minute segments of the livestream, can have a more specific analysis. The sports stream might be about “basketball” for a few minutes before talking about “baseball.” When basketball is being discussed, for example, comments about baseball and other off-topic subjects may be blocked.

Accordingly, at block 1400 in FIG. 14 livestream segments are timestamped and then for each new segment, at block 1402 the relevance filter is reset to reflect the new topic and thus define other topics as being off-topic.

In an even smaller increment of time, the basketball portion may be broken into a minute talking about the “Lakers” and another minute talking about the “Celtics”, with text relating to Celtics being screened out when the discussion concerns the Lakers and vice-versa.

Once the system has an understanding of the topic of the livestream, each audio comment can be processed by the same algorithm. For example, assume a first comment is about “voting rights,” a second topic is about “misinformation,” and a third comment is about “the Astros winning the World Series.” The topical and semantic analysis of the livestream can then be compared to the analysis of the audio comment to determine whether the comment is relevant to the topic of the stream. Thus, even though the third comment about the Astros winning the World Series is not necessarily offensive, it can be filtered out of the comments shown to the politics livestreamer, because it is not relevant to the current topic(s) of the livestream.

Because the livestream content has been analyzed and broken into time blocks related to different topics, a temporal dimension can also be added to the moderation. For example, a comment about “voting rights” that comes more than five minutes after the topic of “voting rights” has last been discussed by the streamer could be filtered out as irrelevant, because the streamer is no longer discussing that topic. The analysis of the audio comments can also filter out comments which aren't necessarily offensive, but which are inappropriate in context. For example, the moderation could filter out parasocial comments that express some love or attraction to the streamer. Things like requests to view certain body parts, requests for a date or to meet in person, expressions of love or affection, personal questions about the streamer's life, requests for personally identifiable information, etc. may be filtered out.

FIG. 15 illustrates that present techniques may be used to help the livestreamer avoid livestreaming objectionable content. The audio of the livestreamer itself is received at block 1500 and at block 1502 is fed into a speech-to-text algorithm to identify objectionable content in the livestreamer's audio. At state 1504 any objectionable audio corresponding to the text analyzed at state 1502 is blocked from being incorporated into the livestream, or a warning might be provided on the livestreamer computer along with the comment that the comment is off-topic or otherwise objectionable. The remainder of the audio may be transmitted in the livestream at block 1506.

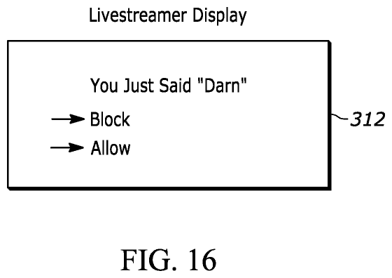

FIG. 16 illustrates that such a warning 1600 may be presented on the livestreamer computer display 312 that the livestreamer just uttered an objectionable word. Selectors 1602 may be provided to allow the liverstreamer to select to allow the term to be sent or to block the audio from the livestream, transmission of which may be delayed by several seconds to give the livestreamer time to decide.

Thus, moderation/censorship can also be applied to the livestreamer's outgoing stream. If the system is analyzing the content of the streamer's audio, it can detect when the streamer says something he shouldn't have and can proactively censor the stream audio to ensure the questionable content isn't broadcast to the audience.

As another example, a livestreamer may accidentally reveal information about where he lives, such as the name of a hometown, a high school, a nearby landmark, etc. Without any kind of screening, that information would go out unfiltered to the audience, and it's impossible to take back once it is out there. This system could mute, “bleep out,” or otherwise censor this sensitive information before it is broadcast to the audience. Alternatively, as divulged above the system can warn the streamer that the streamer just said something objectionable, and the streamer can manually choose to censor that phrase as shown in FIG. 16.

In an additional feature, for a livestreamer to be confident that an audio comment is suitable for broadcast, in addition to analyzing content of the livestream audio additional analysis may be provided including whether overall volume is appropriate (not too loud or too quiet), voice volume relative to background noise is appropriate so that the livestreamer's voice isn't drowned out by noise, whether the amount of background noise is excessive, whether the audio contains uncomfortable or offensive sounds, such as very high or very low frequencies, spikes in volume, gunshots, offensive nonverbal utterances, and the age of speaker using voice age analysis, to disallow children from adding to the stream. This additional analysis may use, as input, audio features such as spectrum, amplitude, and frequency that are input to a ML model trained to detect such irregularities or objectionable sounds on a training set of spectra, amplitude, and frequency along with ground truth labels as to whether the audio components represent objectionable sounds.

While the particular embodiments are herein shown and described in detail, it is to be understood that the subject matter which is encompassed by the present invention is limited only by the claims.

What is claimed is:

1. A system comprising:
at least one computer medium that is not a transitory signal and that comprises instructions executable by at least one processor assembly to:
receive from at least a first viewer of a computer network livestream at least one audio comment;
convert the audio comment to text;
use at least one machine learning (ML) model to process the text to identify whether the text contains first content;
responsive to the text not containing first content, present the text on at least one display of a person generating the livestream; and
responsive to the person selecting the text, send the audio comment with the livestream.

2. The system of claim 1, comprising the at least one processor assembly.

3. The system of claim 1, wherein the first content comprises profanity.

4. The system of claim 1, wherein the first content comprises hate speech.

5. The system of claim 1, wherein the first content comprises personally-identifiable information.

6. The system of claim 1, wherein the first content comprises a topic different from a topic being discussed in the livestream.

7. The system of claim 1, wherein the instructions are executable to allow the person generating the livestream to define the first content to be identified by the ML model.

8. The system of claim 1, wherein the instructions are executable to present on the display along with the text at least one selector selectable to cause the audio comment to be inserted into the livestream.

9. The system of claim 1, wherein the instructions are executable to indicate that first text represents first content for a first segment of the livestream and to indicate that first text does not represent first content for a second segment of the livestream.

10. A method comprising:
analyzing audio associated with a livestream; and
automatically blocking the audio from being included in the livestream responsive to the audio containing a first characteristic.

11. The method of claim 10, wherein the first characteristic comprises one or more of profanity, hate speech, personally-identifiable information.

12. The method of claim 10, wherein the first characteristic comprises off-topic content.

13. The method of claim 10, wherein the first characteristic comprises at least one non-verbal audio feature.

14. The method of claim 10, wherein the audio is spoken by a livestreamer transmitting the livestream.

15. The method of claim 10, wherein the audio is spoken by a viewer of the livestream.

16. An apparatus, comprising:
at least one processor assembly configured to:
identify at least one word spoken by a person associated with a livestream;
identify whether the word is of a class not desired to be presented in the livestream; and
responsive to the word being of a class not desired to be presented in the livestream, block audio of the word from being sent in the livestream.

17. The apparatus of claim 16, wherein the person is a viewer of the livestream.

18. The apparatus of claim 16, wherein the person is a presenter of the livestream.

19. The apparatus of claim 16, wherein the class not desired to be presented in the livestream comprises one or more of profanity, hate speech, personally-identifiable information.

20. The apparatus of claim 16, wherein the class not desired to be presented in the livestream changes segment to segment in the livestream.
